(19) United States
(12) Patent Application Publication
(10) Pub. No.: US 2007/0008239 A1
(43) Pub. Date: Jan. 11, 2007

(54) Communications device interactive display

(75) Inventors: Autumn L. Stroupe, North Bend, WA (US); Daniel G. O'Neil, Seattle, WA (US); David W. Flynt, Lake Forest Park, WA (US); Sayim Kim, Seattle, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/178,119

(22) Filed: Jul. 8, 2005

(51) Int. Cl. G09G 5/00

(52) U.S. Cl. 345/1.1

(57) ABSTRACT

Various new and non-obvious systems and methods are disclosed for interaction between a primary and a secondary display on a portable electronic device. When an event is received at the electronic device, the secondary screen reflects a portion of information about the event. The primary screen is synchronized with the secondary screen such that when the primary screen is accessed (such as by opening a clamshell lid) it reflects the information shown on the secondary screen, as well as potentially adding more information.

### COPYRIGHT AUTHORIZATION

A portion of the disclosure of this patent document contains material which is subject to copyright protection. The copyright owner has no objection to the facsimile reproduction by anyone of the patent disclosure, as it appears in the Patent and Trademark Office patent file or records, but otherwise reserves all copyright rights whatsoever.

### BACKGROUND

Mobile electronic devices, such as personal desktop assistants, contemporary mobile telephones, hand-held computers, tablet personal computers, laptop personal computers, wearable computers and the like are becoming popular user tools. In general they have become small enough to be extremely convenient, while consuming less battery power, and at the same time have become capable of running more powerful applications. Current communication devices often have formfactors which include “clamshells,” devices which fold to cover a primary screen which is used for the bulk of the user interface. These phones often have a secondary screen on the outside of the device which provides some status information, such as signal strength and time, and also allows a few simple tasks to be performed. However, there is typically little, if any, connection between the secondary display and the primary screen.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Described herein are methods and systems for interactions between a primary and a secondary display on an portable electronic device.

In one aspect, a method includes receiving an event at the device. An event may be either proactive—that is, user-initiated, or reactive—that is initiated from outside, such as receiving an incoming call. An indicator of the event then appears on a secondary display. The primary display is then synchronized with the secondary display such that menu items associated with the event automatically appear on the primary display. The situation works in reverse as well, such that when an event appears on a primary display an indicator of the event also can appear on the secondary display.

In a system implementation, the system comprises a hierarchical menu system, portions of which can be displayed on both a primary and a secondary screen. The primary and secondary screens are synchronized such that the primary and the secondary screens show related material.

Additional features and advantages will become apparent from the following detailed description of illustrated embodiments, which proceeds with reference to accompanying drawings.

### BRIEF DESCRIPTION OF THE FIGURES

FIG. 1 is a block diagram of a suitable computing environment in conjunction with which described embodiments may be implemented.

FIG. 2 is a block diagram of a suitable communication device in conjunction with which described embodiments may be implemented.

FIG. 3 is a diagram of a general display layout in conjunction with which described embodiments may be implemented.

FIG. 4 is a diagram of a general system layout in conjunction with which described embodiments may be implemented.

FIG. 5A illustrates an example secondary display for interacting with a calendar reminder application.

FIG. 5B extends the illustration in 5A showing a secondary display interacting with an example primary display within a calendar reminder application.

FIG. 6 is a flow diagram illustrating a method for interaction between a primary and a secondary display.

FIG. 7 is a block diagram illustrating an exemplary system embodiment of interaction between a secondary and a primary display.

FIG. 8 illustrates example embodiments of secondary and primary displays within a music application.

FIG. 9 illustrates example embodiments of secondary and primary displays within a phone call application.

### DETAILED DESCRIPTION

The present application relates to technologies for electronic devices with both primary and secondary displays. Described embodiments implement one or more of the described technologies.

Various alternatives to the implementations described herein are possible. For example, embodiments described with reference to flowchart diagrams can be altered by changing the ordering of stages shown in the flowcharts, by repeating or omitting certain stages, etc. As another example, although some implementations are described with reference to specific user interfaces, other user interfaces also can be used.

The various technologies can be used in combination or independently. Different embodiments implement one or more of the described technologies. Some technologies described herein can be used in a mobile computing device, such as a mobile telephone, a handheld computer, a wearable computing device, a PDA, a media player such as a portable video player, a digital music player, a CD player, or a camera. Other embodiments may be used in some other electronic device, for example a desktop computer, a computer game machine, a DVD, a laserdisc, a VCR, a videocd player, a digital video recorder, or a device that possesses multiple functions such as a mobile telephone-camera, or a portable video player-digital music player. Any of these players may use various formats; for example, a digital music player may use, by way of illustration and not limitation, any combination of the following formats: MP3, WAV, OGG, WMA, or VQF.

I. Computing Environment

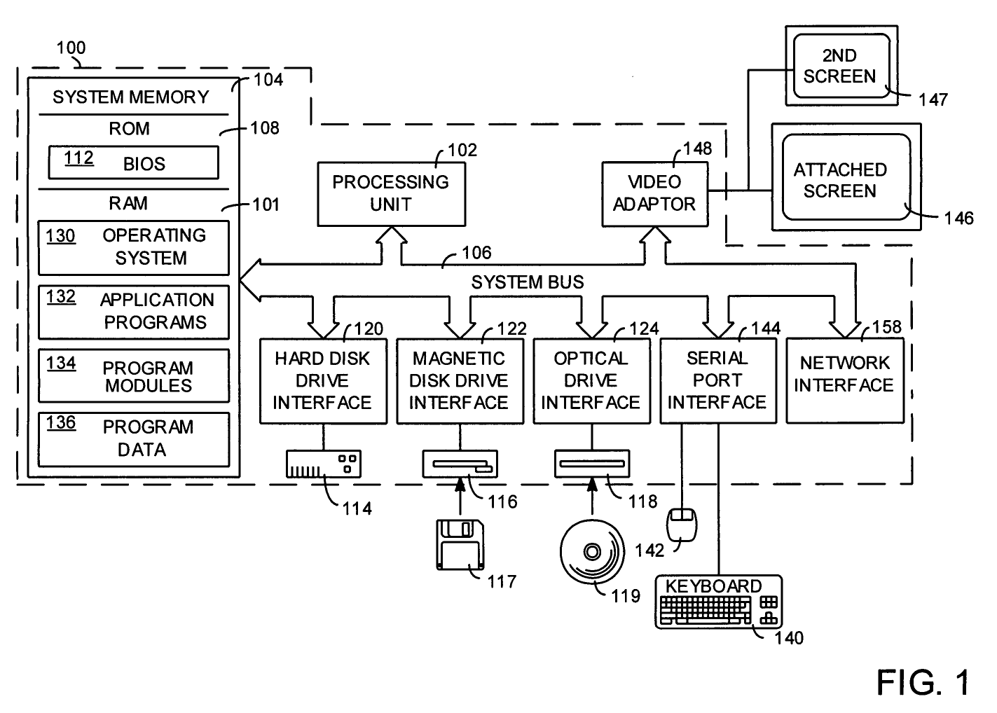

With reference to FIG. 1, an exemplary system for implementing at least portions of the disclosed technology includes a general purpose computing device in the form of a conventional portable computer 100, including a processing unit 102, a system memory 104, and a system bus 106 that couples various system components including the system memory 104 to the processing unit 102. The system bus 106 may be any of several types of bus structures including a memory bus or memory controller, a peripheral bus, and a local bus using any of a variety of bus architectures. The system memory 104 includes read only memory (ROM) 1708 and random access memory (RAM) 110. A basic input/output system (BIOS) 1712, containing the basic routines that help with the transfer of information between elements within the computer 100, is stored in ROM 108.

The computer 100 further includes one or more of a hard disk drive 114 for reading from and writing to a hard disk (not shown), a magnetic disk drive 716 for reading from or writing to a removable magnetic disk 117, and an optical disk drive 118 for reading from or Writing to a removable optical disk 119 (such as a CD-ROM or other optical media). The hard disk drive 114, magnetic disk drive 116, and optical disk drive 11-8 (if included) are connected to the system bus 106 by a hard disk drive interface 120, a magnetic disk drive interface 122, and an optical drive interface 124, respectively. The drives and their associated computer-readable media provide nonvolatile storage of computer-readable instructions, data structures, program modules, and other data for the computer 100. Other types of computer-readable media which can store data that is accessible by a computer, such as magnetic cassettes, flash memory cards, digital video disks, CDs, DVDs, RAMs, ROMs, and the like (none of which are shown), may also be used in the exemplary operating environment.

A number of program modules may be stored on the hard disk 114, magnetic disk 117, optical disk 119, ROM 108, or RAM 110, including an operating system 130, one or more application programs 132, other program modules 134, and program data 136. A user may enter commands and information into the computer 100 through input devices, such as a keyboard 140 and pointing device 142 (such as a mouse). Other input devices (not shown) may include a digital camera, microphone, joystick, game pad, satellite dish, scanner, or the like (also not shown). These and other input devices are often connected to the processing unit 102 through a serial port interface 144 that is coupled to the system bus 106, but may be connected by other interfaces, such as a parallel port, game port, or universal serial bus (USB) (none of which are shown). A primary screen 146, preferably an integral portion of the computer, is also included. It is also connected to the system bus 106 via an interface, such as a video adapter 148. A secondary display device 147, preferably smaller than the primary display device, is also included, and is in a location, such as on the top of a clamshell lid, where it is inaccessible to the user (or difficult to access) when the primary device is being used.

II. Communication Device

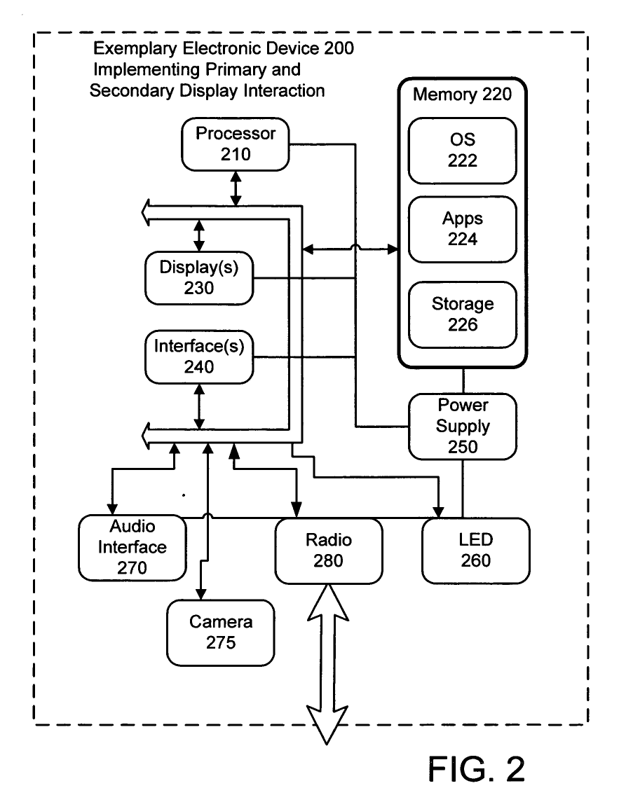

The computing environment may be in the form of a communication device, such as the communication device 200 illustrated as a functional block diagram in FIG. 2. In one implementation, the communication device (200) is a portable mobile communication device. The communication device 200 may be implemented as a personal computer such as those discussed with reference to FIG. 1.

The communication device 200 may include many more components than those shown in FIG. 2. The components shown, however, are sufficient to disclose an illustrative embodiment for implementing the disclosed tools and techniques.

As shown in FIG. 2, the communication device 200 includes a processor 210, a memory 220, one or more displays 230, and one or more input devices 240. The memory 220 generally includes both volatile memory (e.g., RAM) and non-volatile memory (e.g., ROM, Flash Memory, or the like). The communication device 200 includes an operating system 222, such as the Windows Mobile operating system from Microsoft Corporation or other such operating system, which is resident in the memory 220 and executes on the processor 210. The input devices 240 may include one or more keypads. Each keypad may be a push button numeric dialing pad (such as on a typical telephone) or a multi-key keyboard (such as a conventional keyboard). One or more keypads may be sliding, in that the keypad can slide at least partially into or under the communication device 200 reducing the overall footprint. Other input devices such as click-wheels, touch pads, navigation buttons, joysticks, and so forth, may also be included. The display 230 may be a liquid crystal display, or any other type of display commonly used in mobile computing devices. For example, the display 230 may be touch-sensitive, and would then also act as an input device. There may be multiple displays including, in an exemplary implementation, a primary, larger display 230, and a smaller, secondary display 230.

One or more application programs 224 are loaded into the memory 220 and run on the operating system 222. Instructions for implementing interaction between the primary and secondary displays 230 may be included in one or more application programs 224 and/or in the operating system 222. Examples of application programs include phone dialer programs, a switch manager, e-mail programs, calendar programs, word processing programs, spreadsheet programs, media play programs, camera function programs, and so forth. The communication device 200 also includes a non-volatile storage 226 within the memory 220. The non-volatile storage 226 may be used to store persistent information which should not be lost if the communication device 200 is powered down. The application programs 224 may use and store information in the storage 226, such as e-mail, SMS, MMS, or other messages used by an e-mail application, appointment information used by a calendar program, documents used by a word processing application, and the like. A synchronization application may also reside on the communication device 200 and is programmed to interact with a corresponding synchronization application resident on a host computer to keep the information stored in the storage 226 synchronized with corresponding information stored at the host computer.

The communication device 200 also includes a power supply 250, which may be implemented as one or more batteries. The power supply 250 might further include an external power source, such as an AC adapter or a powered docking cradle that supplements or recharges the batteries.

The communication device 200 is also shown with two types of external notification mechanisms: an LED 260 and an audio interface 270. Other components, such as one or more of the displays 230, and vibration devices (not shown) may also operate as notification mechanisms. These devices may be directly coupled to the power supply 250 so that when activated, they remain on for a duration dictated by the notification mechanism even though the processor 210 and other components might shut down to conserve battery power. The LED 260 may be programmed to remain on indefinitely until the user takes action to indicate the powered-on status of the device. The audio interface 270 is used to provide audible signals to and receive audible signals from the user. For example, the audio interface 270 may be coupled to a speaker for providing audible output and to a microphone for receiving audible input, such as to facilitate a telephone conversation.

The communications device 200 may include a camera that allows the device to take pictures.

The communication device 200 also includes a radio 280 that performs the function of transmitting and receiving radio frequency communication. The radio 280 facilitates wireless connectivity between the communication device 200 and the outside world, for example via a communication carrier or service provider. Transmissions to and from the radio 280 are conducted under control of the operating system 222. In other words, communications received by the radio 280 may be disseminated to the application programs 224 via the operating system 222, and vice versa.

The radio 280 allows the communication device 200 to communicate with other computing devices, such as over a network. The radio 280 is an example of communication media discussed above.

III. Display Layout Implementation

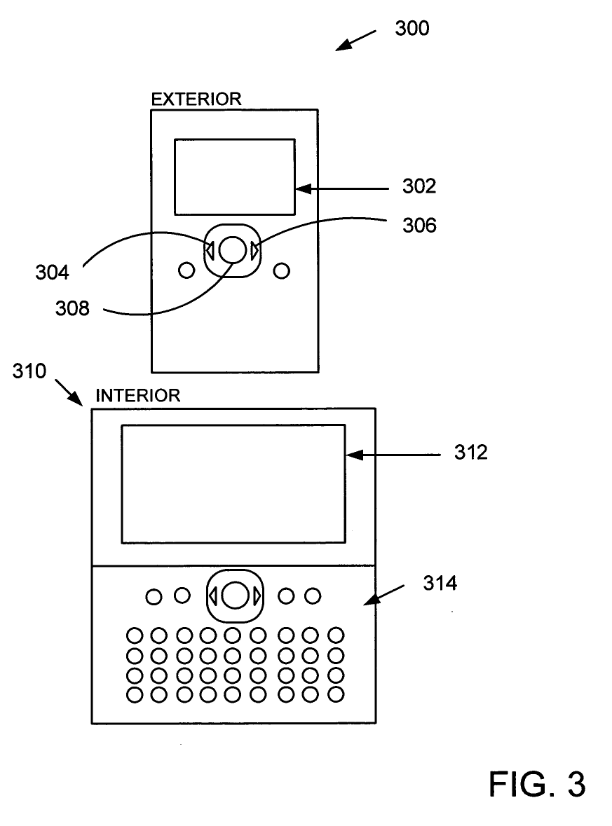

FIG. 3 is a diagram illustrating the layout of an exemplary computing device such as (but not limited to) the communication device 200 described above. The outside of the device 300 comprises an external display screen (the secondary screen) 302 and navigation keys 304, 306, 308. The external display screen 302 is a screen that generally acts as an entry point to other screens and features. However, similar display features can be present on the primary display screen as well, as will become apparent from the description of other screens below. In an exemplary implementation, the secondary screen 302 is larger than secondary displays often found on clamshell devices. The secondary display and primary displays cannot be viewed simultaneously in at least some configurations of the device. For example, when a clamshell device is closed, the primary screen his hidden from view, and the secondary screen is visible. Similarly, with a portable device with a dongle containing a secondary screen, the dongle can be positioned such that the primary screen cannot be seen, such as the main device with the primary screen is placed into a pocket, with the dongle being held.

The user views the external display (secondary) screen 302 to discover the status of the devices, and to receive notifications, reminders and the presence of incoming calls. Generally, the implementation of the secondary display screen 302 illustrated in FIG. 3 includes navigation buttons: a left button 304 a right button 306, and an action button 308. These navigation buttons are used to perform key communication tasks. Each of these hardware buttons is accessible when the communications device is closed.

The navigation keys may be specific to the context of the application or feature that is currently being accessed. Both reactive and proactive tasks can be performed through the external display screen. Reactive tasks—those that happen without current user input—include answering incoming calls, dismissing event reminders, and reviewing message notifications. Proactive tasks—those that are user initiated—include taking pictures, playing music, and syncing information stored in the device (such as addresses, music, data) with an external device. For reactive tasks, the right and left navigation keys 304, 306 are used to change the task displayed in the external display screen 302, while the action key 308 is used to execute the displayed task.

The particular display screens described and illustrated herein are described as particular screens that can implement the described tools and techniques. However, various other types of display screen layouts or other types of user interfaces, such as audio interfaces, could be used.

An exemplary device also includes a primary screen, an example of which is shown at 312. These screens are often associated with “clamshell” formfactors—devices which fold to cover the primary screen when not in use. When such a device is opened up to expose the interior 310, a primary screen 312 is visible. Some embodiment use devices with a secondary screen separable from the main device, such as a device with a dongle.

The primary screen also includes associated hardware buttons 312. These buttons often include but are not limited to a text input keyboard and navigation buttons, but may also include any other form of entry interface. Some embodiments, for example, may have a touch-sensitive primary screen used for most input.

IV. Component-level Implementation

A. Overview

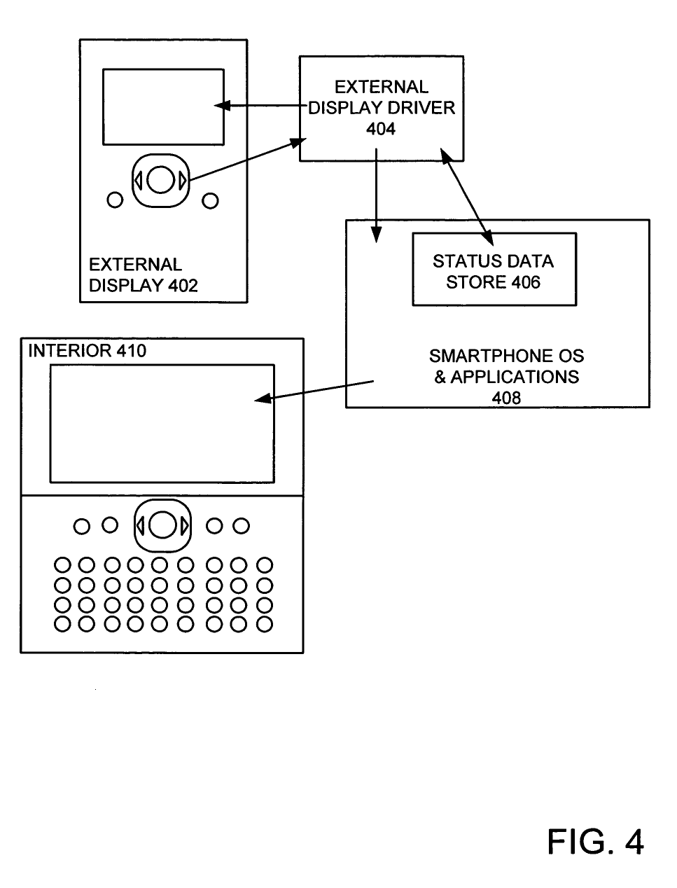

An illustrative embodiment, shown in FIG. 4, comprises four major components: the External Display 402 can be thought of as the secondary display 302, and, at least, the hardware buttons 304, 306, 308, an External Display Driver 404, the OS and Applications 408, and the primary display and associated hardware buttons 410. In an exemplary implementation, the user interacts with user information displayed on the secondary screen 302 to react to notifications and perform simple reactive and proactive tasks. When the user opens the clamshell lid (or otherwise accesses the primary screen), the primary display is preset based on the state of the external display user information.

B. External Display and Hardware Buttons

The External Display (also referred to as the secondary display) 302 in an illustrative embodiment may be larger than secondary displays used in many clamshell devices. A user views the secondary display 302 to consume information about the status of the device (such as how much battery power remains, how strong a signal is) as well as to learn about notifications, reminders, and incoming calls, for example. The user may also navigate through a basic menu and select items from the menu using the navigation buttons 304, 306, 308. In some implementations, a different input device, such as a numeric keypad, a click-wheel, dedicated hardware keys, or a touch screen are used for user-device communication.

C. External Display Driver

The External Display Driver 404 performs several functions. It monitors the status of the Operating System and Applications 408 and sends the appropriate information to the secondary display 302. It also provides the necessary user interface to allow the user to select and perform key tasks. Furthermore, the External Display Driver 404 registers the hardware button presses to allow the user to navigate the secondary display 302 and routes the user information to the Operating System and Applications 408. When the clamshell lid is opened, or when the primary display is otherwise accessed, the External Display Driver 404 captures the signal that is generated and, by passing the information to the Operating System and Applications 408 ensures that the primary display is in the appropriate state.

D. Primary Display and Hardware Buttons

The primary display 312 and hardware buttons 314 are used to view and navigate the user interface for accomplishing tasks. An exemplary implementation includes hardware buttons optimized around text input.

E. Operating System and Applications

The Operating System (OS) and Applications 408 provided may include telephone, text-based messaging, calendaring, music playback, imaging, synching the device with another device or computer, downloading music, e-mail applications, and contact information. In an exemplary application, a component of the OS includes a status data store (StatStore) 406. StatStore 406 reflects the condition (or state) of applications and provides a way for the external display drive 404 to know key information about the state of the OS. The External Display Drive 404 looks to the StateStore 406 for information and displays it in the secondary display 302 when appropriate.

V. Display Synchronization Overview

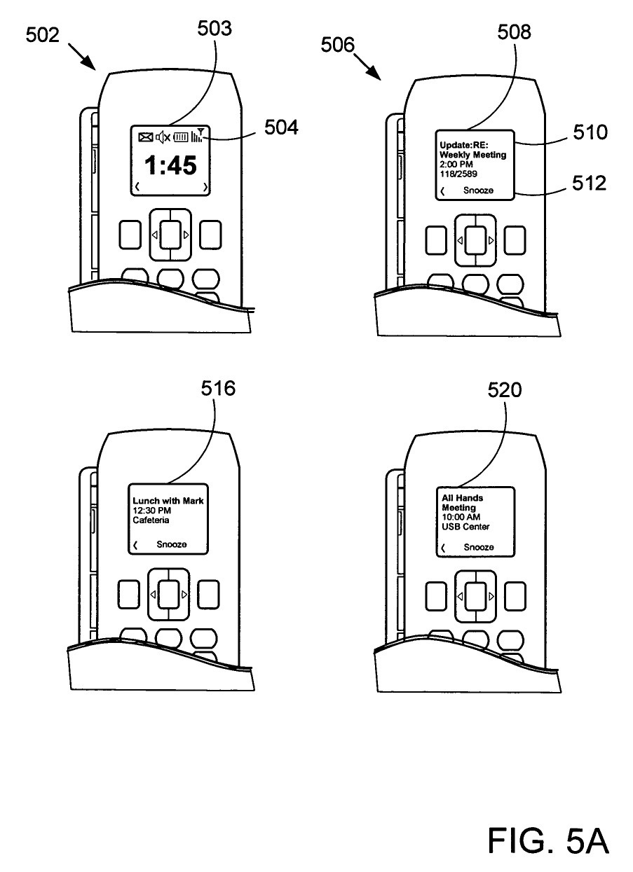

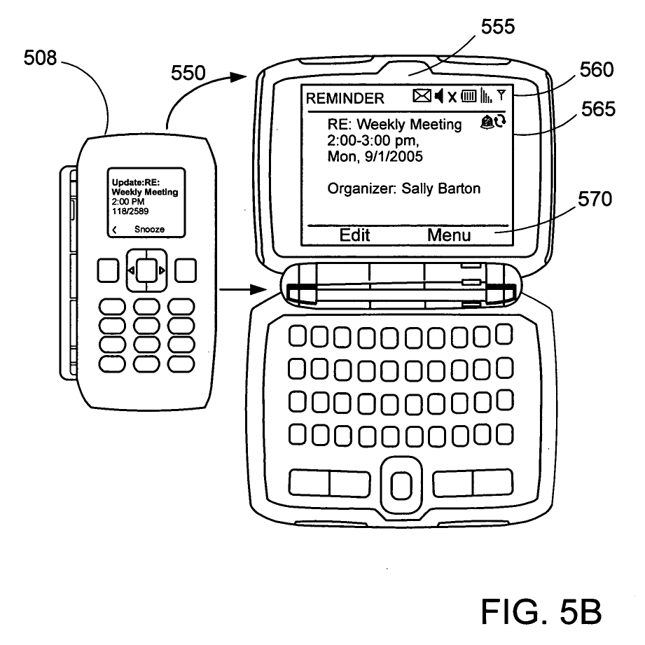

FIGS. 5A and 5B illustrates an example secondary display and an example primary display of a communication device, such as communication device 300, for scenario synchronizing a calendar reminder application. Secondary display 503 includes notification tray 504, while secondary display 508 displays status text 510. Notification tray 504 provides a predictable place for notification icons, such as battery life and signal strength icons.

Status text 510 may communicate information to the user such as the next appointment listed in the user's calendar. Status text 510 may also present additional information associated with the notification icons by using text and updates to support the current notification, such as “Battery Low.”

Turning now to FIG. 5B, primary display 555 is generally larger than secondary display 503. Primary display 555, in the illustrated embodiment, includes notification tray 560 and status text 565. In one embodiment, notification tray 560 follows the model of notification tray 504 shown on secondary display 503. Status text 565 includes additional information to that shown on the secondary display status text 510.

When communication device 300 receives an event notification, information about the event is shown on secondary display 508. For example, as shown in the secondary display 503, at 1:45 PM an appointment notification about an approaching 2:00 PM meeting appears on the secondary display, shown at 508. The user has the choice to dismiss the item by selecting the action button 308—the action that will be taken is shown at 512. Assuming the user does not dismiss (as shown at 540), but instead opens the clamshell (or otherwise activates the primary display) when the clamshell is opened, with no further action on the user's part, status text 560 of primary display 550 shows more information associated with the notification (i.e., the organizer of the meeting). The user is also provided with access to more functionality (i.e., an edit and a menu softkey). Softkeys are actions that can be taken when they are shown on the display. They are selected, generally, with a hardware option, such as an action button 308.

Scenario synchronizing can also be used with other types of proactive and reactive notifications such as new message notifications (e.g., short message service, multimedia message service, e-mail), incoming calls, new voice-mail, and modified settings associated with media applications (e.g., a camera, a music play list, and the like).

VI. Exemplary Method for Interaction Between a Secondary and a Primary Screen Within an Electronic Device

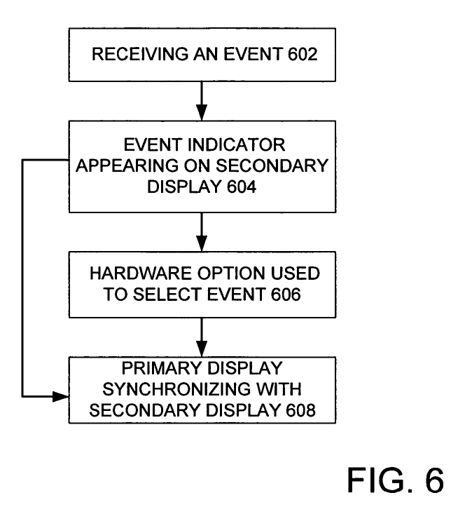

Referring to FIG. 6, and with reference to FIGS. 5A and 5B, flowchart 600 shows an exemplary embodiment of the methods discussed herein. At process block 602, an event is received on an electronic device. At process block 604, an indicator of the event appears on the secondary display. An example of such an event notification can be found at 540. Two types of event indicators—proactive and reactive—can be received, within an exemplary embodiment. Proactive events are those caused by an immediate user action, such as taking a picture, playing music, adding a calendaring event, writing an e-mail, etc. These event indicators are caused by a specific user action at the electronic device, such as selecting a menu option. Reactive events are those that appear without immediate user input, such as the device receiving an incoming call, a calendaring event notification, etc.

A proactive event scenario is shown in FIGS. 5A and 5B. Phone display 502 shows a sample “home” state of the device: in this instance, the time is displayed, and the notification tray is visible. Phone display 508 shows the state of the computing device after an event reminder has been triggered. Display text 510 in the secondary display gives information about the specific reminder, and a softkey (“snooze”) is also displayed. Now, into the reminder menus, selecting the “next” key will transition to the next reminder, as shown in phone display 516. Continuing to select “next” will transition through all remaining event reminders, as shown at 520. Once all event reminders are cycled through, the secondary display returns to the home state 502. From process block 604, processing can continue at either process block 606 or process block 608, depending on user behavior.

At process block 606, a hardware option is used to select the event. Exemplary hardware options include opening a clamshell case or activating a hardware button. The hardware button may be a dedicated button, or it may be associated with a softkey. FIG. 5B shows selecting the reminder shown at 508 by opening a clamshell form factor case 550.

At process block 608, the primary display is synchronized with the secondary display. The primary screen, as shown at 555, can be seen after the clamshell is opened. It has displayed on it information associated with the item originally displayed on the secondary screen 508. In this instance, more information about the meeting 565 is shown. Softkeys 570 are also available, which allows the user to update the information or access a menu.

VII. Exemplary System for Interaction Between a Secondary and a Primary Screen Within an Electronic Device

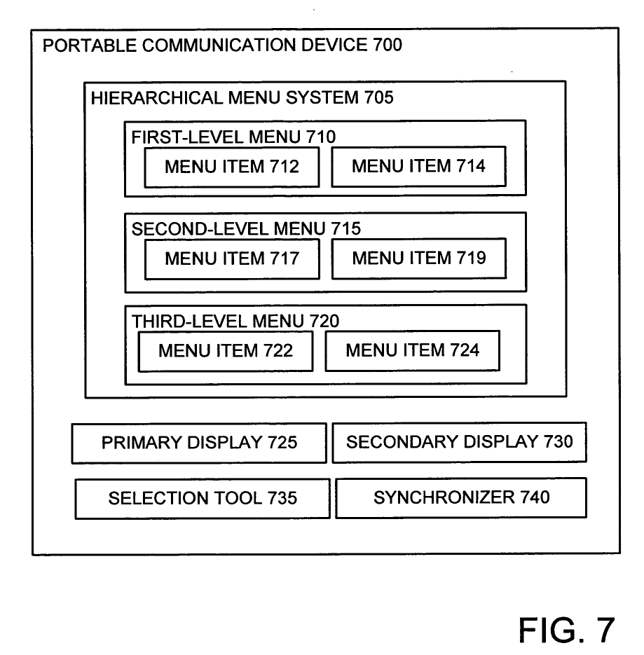

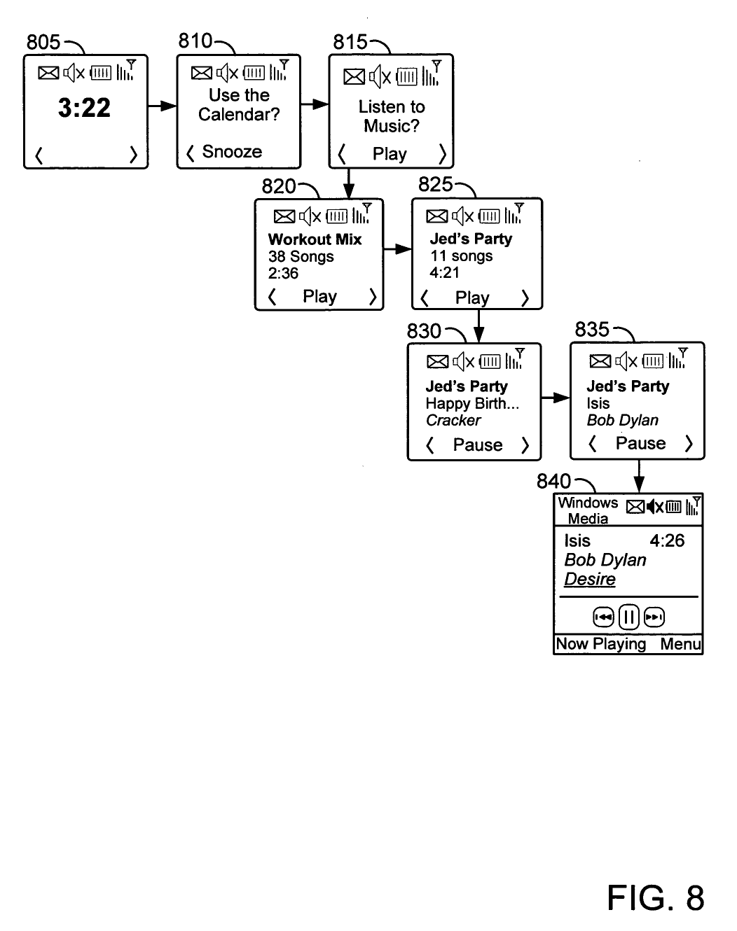

Referring to FIG. 7, and with reference to FIG. 8, Block diagram of a electronic device 700 shows an exemplary embodiment of the systems discussed herein. Electronic device 700 comprises a system with at least three levels of hierarchical menus 715, the first level 720 with at least two menu items 712, 714, the second level 715 having at least two menu items 717, 719; and the third level having at least two menu items 722, 724. The electronics device further comprises at least a primary display 725, a secondary display 730, a selection tool 735 that can be used to choose a menu item, and a synchronizer that is used to synchronize the primary 725 and secondary 730 displays.

FIG. 8 shows an example of a three-level menu system accessible through the secondary display. The secondary display 805 shows a possible home menu state, reflecting a menu item within the first-level hierarchical menu 710. Depressing the “next” hardware button 306 cycles to the next menu item 810, the calendaring application, which displays a calendaring application home screen. Selecting “next” 306 again toggles to the music application 815. Selecting the “action button” 308 opens the music application and displays the next—the second—level 715 of the hierarchical menu system 705.

The second level menu item 717 of the music application displays the first item within the music list. Secondary display screen shot 820 shows the first item in the sample music menu list is “Workout Mix” 820. The user may press the “next” button 306 to toggle to the next second-level menu item 719, or the “previous” button 304 to transition to the previous item. In the example shown, selecting “next” 306 toggles to the next music list, “Jed's Party” 825. Selecting the “action” button 308 transitions to the third-level menu 720 and starts playing the first song, (and the first third-level menu item 722) “Happy Birthday” 830. Once music has started playing, the secondary display shows the current track. The user can pause the music with the “action” button 308; the “previous” button 304 returns to the previous song, while the “next” button 306 advances to the next song. The secondary display screen shot 835 demonstrates selecting the “next” 308 button which selects next third-level menu item 724; play advances to “In My Place.” The user may open the electronic device to view the primary display 725, which is synchronized with the secondary display 730. When within the music menu system, opening (or otherwise accessing) the primary screen will display the media player in playback mode. For example, if the user opens the Primary display when at location 835, Primary display screen shot 840 is shown; in this exemplary embodiment, information about the song being played is shown. Softkeys are also available. From here, the user can, among other functions, quickly see what song lists and songs within the lists are available, for example, without transitioning a song at a time or a list at a time as would be required if interacting exclusively with the secondary display.

If the user did not open the primary display, or closes the primary display, the hierarchical levels of menus may be transitioned back up at the secondary display by selecting the previous menu button.

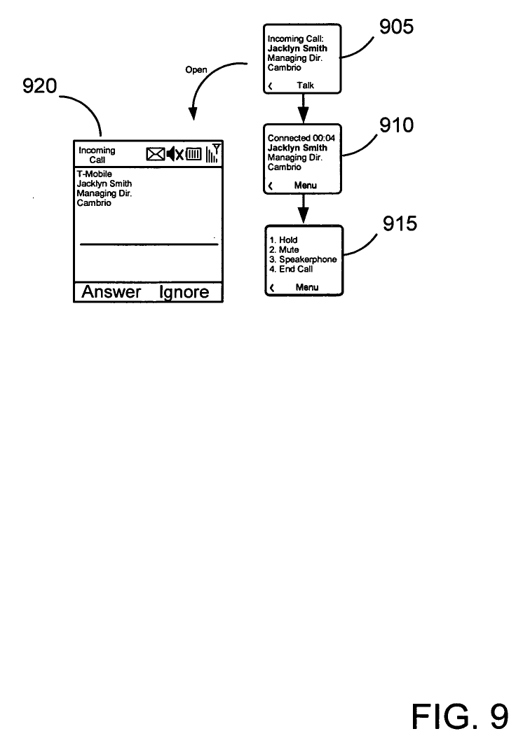

Turning to FIG. 9, screen shot 905 shows a sample secondary screen 730 when a call has just been received, but not yet answered. This is a first-level hierarchical menu item 712, so from this location selecting the “next” 306 or “previous” 304 buttons will toggle through a series of first-level menu functions such as calendaring, playing music, taking a picture, etc. If, before the phone is answered, the primary display 725 is accessed 920, more information is displayed about the caller on the primary display 725; the user is also presented with softkey options “answer” and “ignore.” Alternately, opening the clamshell may answer the call and display options on the primary screen for controlling the call. If the primary screen is closed after the phone is answered (or if the secondary screen is activated in some other fashion), then secondary screen displays other information about the call. In the screen display showed 910, this information includes the call timing, information about the caller, and a softkey “menu” button. If the menu button is chosen, then the menu system descends to the third level, and a user menu appears 915 each choice associated (in this embodiment) with a numeric key. Other embodiments may choose different methods of accessing different menu selections, or may choose not to include a menu in the secondary screen system.

Returning to the secondary display 730, if the “action” button 308 is chosen, the second-level menu item 717 associated with this function is displayed.

VIII. Alternatives

Having described and illustrated the principles of our invention with reference to the illustrated embodiments, it will be recognized that the illustrated embodiments can be modified in arrangement and detail without departing from such principles.

Elements of the illustrated embodiment shown in software may be implemented in hardware and vice versa. Also, the technologies from any example can be combined with the technologies described in any one or more of the other examples.

In view of the many possible embodiments to which the principles of the invention may be applied, it should be recognized that the illustrated embodiments are examples of the invention and should not be taken as a limitation on the scope of the invention. For instance, various components of systems and tools described herein may be combined in function and use. We therefore claim as our invention all subject matter that comes within the scope and spirit of these claims.

We claim:

1. A method for operating a portable electronic device with a primary display and a secondary display, the primary display hidden from the secondary display in at least one device configuration, comprising:
receiving an event at the device,
an indicator of the event appearing on the secondary display, the event having secondary display menu items and primary display menu items, the indicator chosen from among the secondary display menu items,
the primary display synchronizing with the secondary display; and wherein synchronizing comprises at least one primary display menu item automatically appearing on the primary display.

2. The method of claim 1 further comprising a hardware option being activated to select the event.

3. The method of claim 2 wherein the activation of a hardware option comprises at least one of selecting a hardware button or opening a clamshell device.

4. The method of claim 1 wherein the event being received comprises a user-proactive event comprising at least one of: taking a picture, making a call, synching the device with an external device, creating an event reminder, sending an e-mail, interacting with the Internet, listening to stored music, listening to the radio, running a software application, operating a camera associated with the communication device, and setting a timer.

5. The method of claim 1 wherein when the event being received comprises a user-reactive event, and wherein the event being selected comprises at least one of dismissing the event or responding to the event and wherein the user-reactive event comprises at least one of: answering an incoming call, responding to an event reminder, receiving an e-mail, receiving an alarm notification, and receiving a message notification.

6. The method of claim 1 wherein the electronic device further comprises a keypad associated with the secondary display wherein the menu items can be selected using the keypad.

7. The method of claim 1 wherein the electronic device comprises a portable communications device.

8. The method of claim 1, further comprising dismissing information associated with the event from the secondary display.

9. A portable computing system with a primary display and a secondary display, the secondary display unviewable from the primary display in at least one system configuration, comprising:
a hierarchical menu system;
a secondary display operable to display an item from the hierarchical menu system;
a user-activated selection tool operably able to select the displayed menu item;
a synchronizer;
wherein, when the menu item is selected, the synchronizer synchronizes the primary display and the secondary display such that items associated with the displayed secondary menu item, at least a portion not previously displayed on the secondary display, automatically appear on a primary display.

10. The system of claim 9 wherein the user-activated selection tool comprises a repurposed button, a dedicated hardware button, a menu wheel, a joystick, or a hardware button associated with a softkey.

11. The system of claim 9 wherein each menu hierarchy comprises a list of menu items, and wherein the user-activated selection tool comprises a previous button and a next button.

12. The system of claim 11 wherein selecting the previous button will display the previous item in the menu list within the secondary display, and wherein selecting the next button will display the next item in the menu list in the secondary display.

13. The system of claim 9 further comprising an action button and wherein selecting the action button transitions to a next-lower order hierarchical menu, an indicator of the next-lower order hierarchical menu appearing on the secondary display.

14. The system of claim 13 wherein selecting the action button selects the menu item displayed in the secondary display and then again selecting the action button pauses the item selected.

15. The system of claim 9 wherein when the menu item is selected, the synchronizer synchronizes the primary display and the secondary display such that items associated with the displayed primary menu item automatically appear on the secondary display.

16. The system of claim 11 wherein selecting the previous button transitions to the next-higher order hierarchical menu.

17. The system of claim 9 wherein the secondary display is associated with a dongle.

18. The system of claim 9, wherein the secondary display is associated with a keypad possessing keys; wherein at least one menu item is associated with a keypad key, and wherein selecting a menu item comprises selecting the associated keypad key.

19. The system of claim 9, wherein the menu hierarchy comprises at least three levels, and wherein the three levels can be accessed through the secondary display.

20. A portable communication device comprising:
a primary display;
a secondary display; the secondary display unviewable from the primary display in at least one device configuration;
an external display driver operable to detect state information associated with the primary display and state information associated with the secondary display;
an operating system operable to synchronize the primary display and the secondary display based at least in part on the state information captured by the external display driver;
at least one application, an application state associated with the portable communication device, said state reflective of at least either the primary or the secondary screen;
a data store operable to store data, the date comprising at least the state of at least of the primary screen and the state of the secondary screen;
at least one secondary hardware button operable to modify the application state the modification indicated by information displayed on the secondary screen;
at least one primary hardware button operable to modify the application state, the modification indicated by information displayed on the primary display.
